(19) United States
(12) Patent Application Publication
(10) Pub. No.: US 2008/0028982 A1
(43) Pub. Date: Feb. 7, 2008

(54) Single-Component System Based On Co-Reactive Latex, Preparation Method And Use In The Field Of Formol-Free Coatings

(76) Inventors: Christophe Verge, Coye La Foret (FR); Francoise Cochet, Saint-Avold (FR); Sophie Klein, Valmont (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/630,828

(22) PCT Filed: Feb. 2, 2006
(86) PCT No.: PCT/FR05/01547

§ 371 Date: Dec. 22, 2006

(30) Foreign Application Priority Data
Jun. 25, 2004 (FR) 0406996

(51) Int. Cl. C08L 9/10

(52) U.S. Cl. 106/287.2

(57) ABSTRACT

The invention concerns a single-component system based on co-reactive latex capable of leading to formol-free coatings, crosslinkable at room temperature and post-crosslinkable by heat treatment, said system consisting of a mixture of two particle dispersions, (A) and (B) obtained each by emulsion polymerization in aqueous medium of a composition of respectively A and B monomers: (a) at least one free-radical polymerizable ethylenically unsaturated monomer, comprising a functional group, of formula (A), being a constituent of monomer A composition, and (b) at least one free-radical polymerizable ethylenically unsaturated monomer, comprising a radical (R) identical to or different from that of monomer (a); a functional group selected among acetal, mercaptal, mercaptol, dioxolane et dithiolane, being a constituent of monomer B composition. The invention also concerns the preparation method and the use of said system in the field of coatings.

The present invention relates to a single-component system based on a mixture of co-reactive latexes, which is stable during storage, leading to formol-free coatings, which can be cross-linked at ambient temperature and post-cross-linked by heat treatment.

The coatings industry (paint, adhesives, paper, leather, textiles, inks) use latex as binding agents in film forming formulations which in certain cases require a post-cross-linking intended to improve the properties of the coatings obtained, in particular the mechanical properties, resistance to water and to solvents, reduction in superficial tackiness—which allows in particular the reduction, in the case of exterior paints, in the potential for soiling—or also hardness.

This post-cross-linking stage must be adapted to the field of application and to the coating implementation conditions: thus, the paint field requires the operation to be carried out at a temperature close to ambient temperature, or even lower, whilst the textile industry currently uses heat cross-linking methods at temperatures higher than 130° C.

Whatever the intended application, the objective is nevertheless to obtain the most reactive system possible at as low a temperature as possible, whilst being single-component, i.e. ready to use and stable during storage, the two requirements often being in conflict.

Moreover, the constraints regarding protecting people and the environment mean that another objective is to reduce emissions of volatile organic compounds, such as formol (very frequent in the binding agents for the textile industry based on N-methylolacrylamide), or the solvents used for the temporary plasticizing of latex (reduction in the film-formation temperature without reduction in the glass-transition temperature of the copolymer and therefore without reduction in the mechanical properties of the film), etc.

The American patent U.S. Pat. No. 5,468,800, the international Application WO-A-95/09896 and the German patent No. 4439457 describe the use of a monomer with ureido functions in the synthesis of latex leading to formol-free films, which can be cross-linked at ambient temperature by the post-addition of a masked or non-masked polyaldehyde. The possibility of using aldehydes which are copolymerizable is also mentioned, such as (meth) acrolein, or masked aldehydes, such as diethoxypropyl acrylate, methacryloyloxopropyl-1,3-dioxolane, N-(1,1-dimethoxy-but-4-yl)methacrylamide acrylamido-butyraldehyde diethyl acetal, these monomers being combined with the ureido monomer during synthesis of the latex.

The main drawback of these systems lies in their lack of stability during storage. The presence, in the latex, of small reactive molecules which are capable of diffusing in the particles or the coexistence, within the same latex, of two types of co-reactive functions, are in fact capable of inducing a phenomena of pre-cross-linking, which limits the post-cross-linking to the drying stage and in certain cases can even interfere with coalescence.

According to FR-A-2762606 and FR-A-2762607, a single-component system is known based on a mixture of latex capable of fulfilling all of these objectives as it is stable during storage and it leads to films which can be cross-linked at ambient temperature, this cross-linking being activated by a heat treatment at high temperature. The absence of small reactive molecules, which are capable of diffusing into the particles, guarantees better stability during storage, the latex stabilizing system avoiding contact between the particles and therefore reaction between the co-reactive functions until the drying stage. Moreover, the separate synthesis of the two functionalized latexes allows each of the reactive functions to be better preserved, which allows greater efficiency in post-cross-linking during coalescence of the film.

In FR-A-2762607, the single-component systems are obtained by mixing functionalized latex, one by a monomer carrying a ureido type group, and the other by a monomer carrying an N-alkylol type group. The coatings thus obtained have a low free formol level, which is nevertheless not zero.

In FR-A-2762606, the single-component systems are obtained by mixing functionalized latex, one by a monomer carrying a ureido type group, and the other by a monomer carrying a masked or non-masked aldehyde group. The films obtained are completely formol-free, which allows the problem posed in the Application FR-A-2762607 to be resolved. On the other hand, access to the masked or non-masked aldehyde monomers, mentioned in the Application FR-A-2762606 most of which are currently unavailable on a industrial commercial scale, constitutes one of the major drawbacks of this system.

The Applicant has now found a single-component system based on a novel mixture of functionalized latex, which is stable during storage and leads to films which are totally formol-free, can be cross-linked at ambient temperature, this cross-linking being optionally activated by a heat treatment at high temperature.

The invention thus allows an alternative to the problem of commercial availability on an industrial scale of the raw materials described in the Application FR-A-2762606 to be proposed. Moreover, these novel latex compositions allow coatings to be obtained the properties of which, in particular the application properties, are such that the use of the single-component system according to the invention as a binding agent intended for the textile industry, are improved. The results presented for the textile application are accordingly all the more useful as they propose a high-performance alternative to the standard system used in the textile industry, based on N-methylolacrylamide, the main drawback of which is the generation of free formol in the coating during heat treatment of the films.

The novel single-component system comprises a mixture of functionalized latex, one by a monomer carrying a group of urea or ethylene urea type, and the other by a monomer carrying an acetal, mercaptal, mercaptol, dioxolane or dithiolane function.

Therefore a subject of the present invention is firstly a single-component system based on co-reactive latexes, capable of leading to formol-free coatings, which can be cross-linked at ambient temperature and post-cross-linked by heat treatment, said system being constituted by the mixture of two dispersions of particles, (A) and (B), each obtained by polymerization in emulsion in aqueous medium of a composition of monomers A and B respectively:

(a) at least one monomer with an ethylene unsaturation polymerizable by radical route, comprising a functional group, of formula A 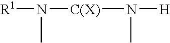
in which

R¹ is a group polymerizable by radical route;

X represents O or S, entering into the composition of monomers A; and

(b) at least one monomer with an ethylene unsaturation polymerizable by radical route, comprising

an 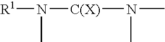
radical identical or different to that of monomer (a), in which R¹ is a group polymerizable by radical route and X represents O or S;

a functional group chosen from acetal, mercaptal, mercaptol, dioxolane and dithiolane, of formula B1
B1: —CHOH-(G)-CH(YR³)(ZR⁴)
in which:

Y and Z, identical or different, represent O or S;

G represents a direct bond or a C₁-C₄ alkylene radical;

R³ and R⁴, identical or different, each represent a hydrogen atom or a C₁-C₈ alkyl group, or together form a —CH₂—CR⁵R⁶—(CH₂)ₙ— group where n=0 or 1 and R⁵ and R⁶, identical or different, each represent a hydrogen atom or a methyl group, entering into the composition of monomers B.

The monomers (a) can be chosen from those represented by the formulae (I) to (V) hereafter: 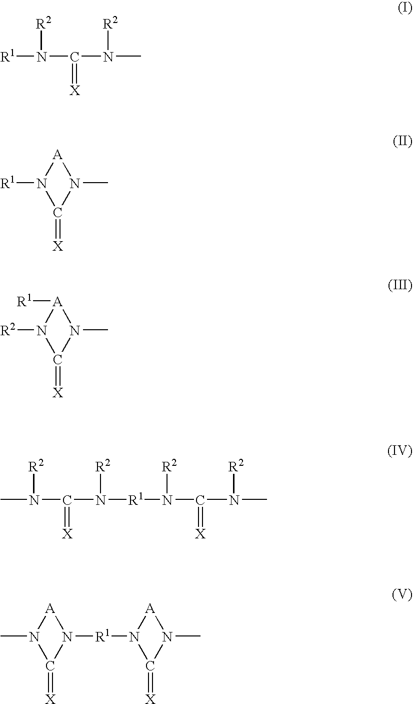
in which: X represents O or S;

R¹ is a group with an ethylene unsaturation, polymerizable by radical route;

R² is a hydrogen atom or a C₁-C₈ alkyl group; and

A is an alkylene chain with 2 or 3 carbon atoms which can be substituted by C₁-C₄ lower alkyl and/or hydroxy and/or C₁-C₄ alkoxy, and/or which can be interrupted by a carbonyl group.

The R¹ group can be chosen from the following groups:

CH₂═CH—

CH₂═CH—CH₂—

CH₂═C(CH₃)—CH₂—

CH₂═CH—C(O)—

CH₂═C(CH₃)—C(O)—

CH₂═CH—CH₂—O—CH₂—CH(OH)—CH₂—

R⁷-A¹-Alk

where:

R⁷ represents a hydrogen atom, a 3-alkyloxy-2-hydroxypropyl, vinyl, methacryloyl, acryloyl or methacryloyloxyaceto group;

A¹ represents 0, NH or NR⁸;

R⁸ represents 3-allyloxy-2-hydroxypropyl when R⁷ represents 3-allyloxy-2-hydroxypropyl;

Alk represents a C₂-C₈ alkylene chain; and

2-(beta-carboxyacrylamido)ethyl

R⁹-A²-C(O)—CH═CH—C(O)-A²-R⁹

where:

A² represents O or NH;

R⁹ represents a C₁-C₄ alkylene group.

By way of examples of monomers (a), there can be mentioned N-(2-methacryloyloxyethyl)ethylene urea, N-(2-acryloyloxyethyl) ethylene urea, N-(methacrylamidomethylene) ethylene urea, N-(acrylamidomethylene)-ethylene urea, N-(beta methacrylamidoethyl)-ethylene urea, N-(beta acrylamidoethyl-ethylene urea, N-vinyl-ethylene urea, N-vinyloxyethyl-ethylene urea, N-[beta methacryloyloxy-acetamido)-ethyl]-N,N′-ethylene urea, N-[beta-acryloyloxyacetamido)-ethyl]-ethylene urea, 1-[2-[[2-hydroxy-3-(2-propenyloxy)propylamino]ethyl]-2-imidazo-lidone, N-methacrylamidomethyl urea, N-methacryloyl urea, N-(3-[1,3-diazacyclohexan-2-one]propyl)methacrylamide, N-hydroxyethylethylene urea, N-aminoethyl ethylene urea, N-(3-allyloxy-2-hydroxypropyl) aminoethyl ethylene urea, N-methacrylaminoethyl ethylene urea, N-acrylaminoethyl ethylene urea, N-methacryloxyacetoxyethyl ethylene urea, N-methacryloxy-acetaminoethyl ethylene urea and N-di(3-allyloxy-2-hydroxy-propyl) aminoethyl ethylene urea, N-(2-acryloyl-oxy-ethyl) ethylene urea, N-methacrylamidomethyl urea, allyl alkyl ethylene ureas and the compounds obtained by the reaction between an unsaturated dicarboxylic acid diester and a hydroxyalkylalkylene urea, an aminoalkylalkylene urea, a hydroxyalkylurea or an aminoalkylurea In particular, there can be mentioned the reaction products of hydroxyethylethylene urea with dimethyl maleate, diethyl maleate, dimethyl fumarate or diethyl fumarate and in particular the compound Cylink C4 marketed by Cytec.

A particularly preferred monomer (a) is N-(2-methacryloyloxyethyl)-ethylene urea, also called 1-(2-methacryloyloxy-ethyl)-imidazolin-2-one or ethyl imidazolidone methacrylate (EIOM).

As regards monomer (b), the radical 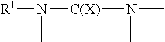
can be identical or different to that of monomer (a); the definitions of R¹ and X can be identical or different in monomers (a) and (b). Preferably this radical is identical; in particular it is obtained by in-situ synthesis in the polymerization medium, of monomer (b) from monomer (a).

In particular, this monomer (b) carrying a functional group chosen from acetal, mercaptal, mercaptol, dioxolane and dithiolane, of formula B1
B1: —CHOH-(G)-CH(YR³) (ZR⁴) in which

Y and Z, identical or different, represent O or S;

G represents a direct bond or a C₁-C₄ alkylene radical;

R³ and R⁴, identical or different, each represent a hydrogen atom or a C -C₈ alkyl group, or together form a —CH₂—CR⁵R⁶—(CH₂)ₙ— group where n=0 or 1 and R⁵ and R⁶, identical or different, each represent a hydrogen atom or a methyl group, is generated in situ in the polymerization medium by reaction between a precursor monomer carrying a group of urea or ethylene urea type (monomer (a)) and a compound carrying an aldehyde function and precursor of the acetal, mercaptal, mercaptol, dioxolane or dithiolane function of formula B′1 CHO-(G)-CH(YR³)(ZR⁴) in which G, Y, Z, R³, R⁴ are as defined above.

By way of examples, the compound carrying an aldehyde function and precursor of the acetal, mercaptal, mercaptol, dioxolane or dithiolane function can be chosen from 2,2-dimethoxyacetaldehyde, 2,2-diethoxyacetaldehyde, 2,2-dipropoxy-acetaldehyde, 2,2-dibutoxyacetaldehyde, 3,3-dimethoxypropanal, 3 ,3-diethoxy-propanal, 3,3-dipropoxypropanal, 3,3-dibutoxypropanal, 4,4-dimethoxybutanal, 4,4-diethoxybutanal, 4,4-dipropoxybutanal, 4,4-dibutoxybutanal, 5,5-dimethoxypentanal, 5,5-diethoxypentanal, 5,5-dipropoxypentanal, 5,5-dibutoxypentanal, 6,6-dimethoxy-hexanal, 6,6-diethoxyhexanal, 6,6-dipropoxyhexanal and 6,6-dibutoxyhexanal.

A particularly preferred compound carrying an aldehyde function and precursor of the acetal function is 2,2-dimethoxyacetaldehyde, also called 1,1-dimethyl acetal glyoxal or 2,2-dimethoxyethanal.

Thus, the single-component system based on a mixture of co-reactive latexes according to the invention, has in particular the advantage of using precursor monomers which are commercially available, which can simplify the synthesis of cross-linkable films.

Once synthesized, these latexes can be mixed without producing any reaction between the above-mentioned functions during storage, and they lead either during or after to the coalescence at ambient temperature to a cross-linked film which has improved properties compared to the base latex, said cross-linking being able to be activated by a heat treatment.

This novel combination of latex is all the less obvious as it is not sufficient for the above-mentioned functions to react with each other during or after the coalescence, as it is also required that the kinetics of cross-linking do not disturb the coalescence of the particles and therefore the formation of the film at too high a rate of cross-linking could in fact interfere with the formation of the film and render a system unusable.

According to the invention, the separate syntheses of the two functionalized latexes make it possible to better preserve each of the functions—the polymerization temperature generally being greater than ambient temperature—which allows a greater post-cross-linking efficiency during the coalescence of the film (interdiffusion of the chains leading to the reaction between the functional groups): in fact, if the two functions are combined in the same latex, pre-cross-linking would occur and therefore little or no post-cross-linking and even perhaps coalescence problems.

Another advantage lies in the fact that the absence of small reactive molecules, which can diffuse into the particles, guarantees better stability during storage, since, when in a latex state, the latex stabilizing system prevents contact between the particles, and therefore reaction between the two types of co-reactive functions carried by each of the dispersions.

The preparation of the monomer (b) is carried out under standard conditions of reaction between a urea or ethylene urea function and an aldehyde function. By way of example reference can be made to the patents FR-A-2595694, FR-A-2613361 and FR-A-2787458.

The present invention also relates to a method for the preparation of the single-component system according to the invention, comprising the following stages:

(i) provision of at least one monomer (a) and at least one monomer (b);

(ii) polymerization in emulsion in aqueous medium of each of the compositions of monomers (a) and (b) separately, and the obtaining of dispersions of particles (A) and (B) respectively and

(iii) mixture of the dispersions.

According to a preferred embodiment, the method comprises in addition an in-situ synthesis stage of monomer (b) by reaction of a composition of monomer (a) with a precursor compound carrying an aldehyde function and an acetal, mercaptal, mercaptol, dioxolane or dithiolane function, of formula B′1 CHO-(G)-CH(YR³)(ZR⁴).

Preferably, the monomers (a) and/or (1) represent 0.5 to 10% by weight, in particular 1 to 5% by weight, of the composition of monomers A and B respectively. The monomers (a) and (b) can be introduced in a homogeneous fashion with the other monomers or in composition gradients which makes it possible to produce products having the different densities of functions. The proportions of the two co-reactive latexes according to the present invention are chosen such that the proportion of polymer (A) is comprised between 5 and 95% by weight, in particular between 25 and 75% by weight, of polymers (A) and (B), and the proportion of polymer (B) is comprised between 95 and 5% by weight, in particular between 75 and 25% by weight, of polymers (A) and (B), the dry extracts of each of the dispersions being generally comprised between 20 and 60% by weight.

Moreover, the dimensions of the particles of each of the dispersions (A) and (B) are in particular comprised between 50 and 500 nm.

The monomers other than the monomers (a) and (b) of the two dispersions of particles (A) and (B) of the invention are not critical, from the moment when the glass transition temperatures (Tg) of the resultant copolymers have been adapted to the intended field of application. The combination of monomers capable of producing homopolymers having different glass-transition temperatures therefore makes it possible to adjust the glass-transition temperature of each of the copolymers obtained, i.e. by the combination of monomers leading to high Tgs with monomers leading to low Tgs, which is well known to a person skilled in the art.

By way of examples of monomers capable of leading to of homopolymers having a low Tg, the following can be mentioned: ethyl acrylate, butyl acrylate, 2-ethyl hexyl acrylate, nonyl acrylate, vinyl 2-ethyl hexanoate, etc. By way of examples of monomers capable of leading to homopolymers having a high glass-transition temperature, the following can be mentioned: methyl methacrylate, vinyl acetate, styrene, acrylic acid, methacrylic acid, 1 acrylamide, etc.

The two latexes according to the invention are prepared by polymerization in emulsion under conditions well known to a person skilled in the art. Thus, the reaction is preferably carried out under an inert atmosphere in the presence of radical initiators. The initiation system used can be a redox system such as K₂S₂O₈, (NH₄)₂S₂O₈/Na₂S₂O₅, Na₂SO₃, a thermal system such as (NH₄)₂S₂O₂, the quantities used being comprised between 0.2 and 1.0% by weight with respect to the total mass of the monomers, preferentially between 0.25 and 0.5% by weight.

The polymerization reaction in emulsion according to the invention is carried out at a temperature comprised between 65 and 85° C. and is a function of the nature of the initiation system used; 65-75° C. for the redox systems based on peroxodisulphate and metabisulphite, 70-85° C. for the thermal systems based on peroxodisulphate alone.

The preparation of the dispersions according to the invention is preferably carried out according to a method of semi-continuous type, making it possible to limit the composition derivates which are a function of the differences in reactivity of the different monomers. The introduction of the monomers in the form of a pre-emulsion with a water portion and surfactants is thus generally carried out over a time period of 3 hours 30 minutes to 5 hours. It is also useful, although not indispensable, to carry out an initiation of 1 to 15% of monomers. The emulsifying systems used in the polymerization method in emulsion according to the invention are chosen from the range of emulsifiers having a suitable hydrophilic/lipophilic balance. The preferred systems are constituted by the combination of an anionic surfactant, such as sodium lauryl sulphate, the ethoxylated nonylphenol sulphates in particular with 20-25 moles of ethylene oxide, benzene dodecylsulphonate and the ethoxylated fatty alcohol sulphates, in particular with 20-25 moles of ethylene oxide and a non ionic surfactant, such as the ethoxylated nonylphenols in particular 10-40 moles of ethylene oxide and ethoxylated fatty alcohols in particular 10-40 moles of ethylene oxide. The total quantity of emulsifier is generally comprised within the range 1 to 5% by weight and preferentially 2 to 4% by weight with respect to the monomers.

The mixtures of the dispersions (A) and (B) according to the invention are in general carried out at ambient temperature.

The cross-linking at ambient temperature can in general take place at temperatures comprised between 15 and 30° C., whilst post-cross-linking can in general take place at temperatures comprised between 100° C. and 200° C., preferably comprised between 120° C. and 170° C. The films originating from the latex mixtures according to the invention have been analyzed as obtained after one week of film formation at ambient temperature (23° C.), followed or not followed by an additional heat treatment of 75 minutes at 160° C.

The properties of the films which have been evaluated are the mechanical properties of the film using a tensile test which produces breaking strain and stress values, the objective being to obtain a film which is both resistant and deformable.

The degree of cross-linking of the films—which governs the good application properties of the latter—is characterized here by a stress and elongation at break which are as high as possible.

The cross-linking at ambient temperature of the film originating from the mixture of latexes A+B is demonstrated by obtaining properties which are superior to those of two reference latexes, one non functionalized and the other N-methylolacrylamide functionalized, as well as those of latexes A and B taken separately.

The existence of temperature cross-linking of the films is demonstrated by comparison of the properties before and after a heat treatment of 75 minutes at 1 60° C. as well as by comparison with a reference latex functionalized by 5 parts N-methylolacrylamide.

Under these conditions, it has been observed that the mixture of a latex A functionalized by a monomer carrying a ureido function (ethyl imidazolidone methacrylate/EIOM) with a latex B functionalized by a monomer carrying an acetal function, optionally generated in situ from a precursor monomer carrying a ureido function (EIOM) in the presence of a compound which is precursor of the acetal (2,2-dimethoxyethanal) function leads to a film which cross-links at ambient temperature and the cross-linking of which is increased by a heat treatment. Its properties are superior to those of latexes A and B taken separately. In addition, the synthesis route chosen for monomer (b), preferentially generated in-situ in the polymerization medium at the stage of mixing the monomers entering into the composition of dispersion (B), allows a easy and low-cost access to the basic raw material of latex B.

After heat treatment at high temperature, the properties of the film originating from the mixture of latexes A+B are moreover superior to those obtained with a reference latex functionalized by 5 parts N-methylolacrylamide.

The application performances of the single-component system according to the invention, in other words the possibility of improving the final properties of the latex films used as coatings, and in particular the resistance to water and solvents, are demonstrated by determination of the mechanical properties (dry, in aqueous medium and in alcoholic medium) of a film of non-woven coating of the mixture of latexes A+B and the comparison of these properties with those obtained under the same conditions for latex A alone, as well as for a reference latex based on N-methylolacrylamide (binding agent application for textiles).

The present invention also relates to the use of the single-component system based on co-reactive latexes, as defined above, as a binding agent in compositions intended to constitute a cross-linkable formol-free coating, such as a paint in the building field, a varnish or a dressing for leather, a finish for textiles, a wood-protection varnish, or in compositions for the coating of paper; as a binding agent and/or an impregnation agent for various woven or non-woven textile materials, paper, cardboard, laps; and as an adhesive, in particular in the wood industry.

The following examples illustrate the present invention without however limiting its scope. In these examples, the portions and percentages are by weight except where indicated otherwise. In Example 1, the quantities of the ingredients of the formulations and of the monomers are expressed in portions of active materials.

### EXAMPLE 1

### Synthesis and Characterization of the Latexes

General Operating Method

A starter formulated as follows is introduced into a 3 1 reactor, equipped with hot water circulation in the double jacket, central stirring and a condenser:

Starter

| | | |
|---|---|---|
| Water | 75.00 | parts |
| 33% Ethoxylated fatty alcohol sodium sulphate in water | 0.25 | parts |
| (Disponil FES 77 marketed by Cognis) | | |
| 70% Ethoxylated fatty alcohol in water | 0.05 | parts |
| (Disponil AFX 3070 marketed by Cognis) | | |

The medium is homogenized and taken to 80° C. When the temperature of the starter reaches 80° C., over a period of 4 hours for the pre-emulsion and 4 hours 30 minutes for the initiator solution, the two mixtures formulated as follows are poured:

Pre-Emulsion

| | | |
|---|---|---|
| Water | 75.00 | parts |
| 33% Ethoxylated fatty alcohol sodium sulphate in water | 2.25 | parts |
| 70% Ethoxylated fatty alcohol in water | 0.45 | parts |
| Monomers | 100.00 | parts |

The surfactants are solubilized in water beforehand, then the monomers added one by one in decreasing order of hydrophily, under magnetic stirring.

Initiator Solution

| | |
|---|---|
| Water | 6.00 parts |
| Sodium persulphate | 0.30 parts |

The medium is left to react for another hour at 80° C., followed by cooling down to ambient temperature and filtering on a 200 micron filter cloth.

Preparation and Characteristics of the Synthesized Latexes

Latexes A and B are synthesized from monomers A and B respectively as indicated in Table 1, in which the characteristics of the latexes obtained are also indicated.

In the case of latex B, the acetal functionalized monomer (b) is obtained in-situ in the polymerization medium by mixing, in the pre-emulsion preparation stage, precursor monomer carrying the ureido function (EIOM) and precursor compound of the acetal function (2,2-dimethoxyethanal), at ambient temperature and at a pH greater than or equal to 7.

Compound 1 is a non-functionalized reference latex.

Compound 2 corresponds to a reference latex functionalized by 5 parts by mass of N-methylolacrylamide.

TABLE 1

| | | | |
|---|---|---|---|
| Latex A | Latex B | Comp. 1 | Comp. 2 |

Monomers

| | | | | |
|---|---|---|---|---|
| Methyl methacrylate | 42 | 43 | 50 | 45 |
| Butyl acrylate | 46 | 46 | 50 | 48 |
| AMPS⁽¹⁾ | 2 | — | — | — |
| Acrylic acid | — | 1 | — | 2 |
| Ethyl imidazolidone | 10 | 10 | — | — |
| methacrylate (EIOM)⁽²⁾ | | | | |
| 2,2-dimethoxyacetaldehyde⁽³⁾ | — | 2.25⁽⁴⁾ | — | — |
| N-methylolacrylamide | — | — | — | 5 |
| (48% aqueous solution) | | | | |

Characteristics

| | | | | |
|---|---|---|---|---|
| Dry extract(%) | 39.5 | 40 | 39.4 | 40 |
| PH | 1.5⁽⁵⁾ | 6.4 | 2.2 | 5.8 |
| Diameter (nm) | 192 | 179 | 160 | 260 |
| Viscosity (mPa · s) | 65 | 65 | 40 | 570 |

⁽¹⁾Acrylamido methyl propane sulphonic acid (Aldrich)
⁽²⁾Solution of ethyl imidazolidone methacrylate with 50% active ingredient in methyl methacrylate, marketed by Atofina (Norsocryl 104).
⁽³⁾2,2-dimethoxyacetaldehyde with 60% active ingredient in water, marketed by Clariant (Highlink DM).
⁽⁴⁾Molar ratio (EIOM/2,2-dimethoxyacetaldehyde) (ureido/aldehyde) = 1.
⁽⁵⁾Final latex neutralized to pH = 8 by adding a soda solution.

### EXAMPLE 2

### Properties of the Latexes Obtained, A, B, Comp 1. Comp 2, Coreactive Mixture A+B

The mechanical properties of the films originating from the latexes synthesized separately in Example 1 were determined after a week of drying at 23° C., 50% relative humidity, followed or not followed by a heat treatment of 75 minutes at 160° C.

The latexes A and B were mixed in equimolecular quantities of ureido and acetal functions. The properties of the films originating from this mixture were also examined after a week of drying at 23° C., 50% relative humidity, followed or not followed by a heat treatment of 75 minutes at 160° C.

The test used is a tensile test with significant strains, carried out in accordance with the standard ISO 527.

The results (average value calculated over a minimum of 3 measurements) are reported in Table 2.

TABLE 2

| | |
|---|---|
| Drying at 23 C. | Drying at 160 C. |

| Latex | ε_{R} (%)⁽¹⁾ | σ_{R} (MPa)⁽¹⁾ | E_{R} (%) | σ(MPa) |
|---|---|---|---|---|
| Comp. 1 | 419 | 5.9 | 429 | 5.9 |
| Comp. 2 | 403 | 2.9 | 333 | 12.9 |
| A | 226 | 4.9 | 276 | 12.7 |
| B | 272 | 6.1 | 291 | 7.0 |
| Equimolar | 170 | 12.2 | 178 | 19.7 |
| mixture of | | | | |
| A + B | | | | |

⁽¹⁾Strain at break, expressed in %
⁽²⁾Stress at break, expressed in MPa

The film obtained from the functionalized reference latex N-methylolacrylamide (comp 2) demonstrates the absence of cross-linking at ambient temperature, but a strong tendency to thermal cross-linking (increase in stress at break). The films originating from latexes A and B taken separately and dried at lo ambient temperature exhibit a certain degree of cross-linking demonstrated by a significant reduction in strain at break compared with the non-functionalized reference latex (comp 1). The film of latex A has a tendency to thermal cross-linking (increase in the stress at break after treatment at 160° C.), not observed in the case of latex B.

After drying at ambient temperature, the film obtained from the equimolecular mixture of the co-reactive latexes A and B has a stress at break greater than that of the two reference latexes and to that of latexes A and B taken separately, demonstrating strong cross-linking at ambient temperature. This cross-linking is increased by a post-heat treatment of the films at 160° C., which makes it possible to increase the stress at break by approximately 60% without however reducing the strain at break and therefore the ability of the film to become deformed without breaking. The mechanical properties obtained after heat treatment of the film originating from the mixture of latexes A+B are not only greater than those of latexes A and B alone, but also more than 50% greater than those of the functionalized reference latex N-methylolacrylamide (Comp. 2).

### EXAMPLE 4

### Application Properties for Impregnation of Nonwovens (Textile Binder Application)

The test used involves determining the tensile-strength properties of non-woven films impregnated with latex, then dried for 1 minute 30 seconds at 105° C. and heat-treated for 5 minutes at 130° C. These tests are carried out dry or after immersion of the nonwoven in a liquid (water, ethanol), in accordance with standard ISO 9073 describing the test methods for nonwovens in the field of textiles.

Table 3 shows the results obtained for latex A alone, the mixtures of latexes A+B in different ureido/acetal molar rations as well as a reference latex functionalized by 5 parts of N-methylolacrylamide (comp 2).

The results are expressed as force values necessary to break the sample (N/m).

TABLE 3

| | Dry strength | Wet strength | Alcohol strength |
|---|---|---|---|
| Latex | (N/m) | (N/m) | (N/m) |
| Comp 2 | 2071 | 1307 | 710 |
| A | 2060 | 940 | 492 |
| Mixture of A + B | 1944 | 1219 | 972 |
| (R = 1)⁽¹⁾ | | | |
| Mixture of A + B | 2145 | 1161 | 996 |
| (R = 1.2)⁽²⁾ | | | |

⁽¹⁾Molar ratio (acetal/ureido) = 1
⁽²⁾Molar ratio (acetal/ureido) = 1.2

From the three tests carried out, the resistance in alcohol medium of nonwovens impregnated with latex, which is also the most severe, demonstrates the superiority of the A+B mixtures not only compared with latex A alone but also compared with the reference latex functionalized by N-methylolacrylamide, considered as reference latex for textile binder application.

1. Single-component system based on co-reactive latexes, suitable for leading to formol-free coatings, which can be cross-linked at ambient temperature and post-cross-linked by heat treatment, said system being constituted by the mixture of two dispersions of particles, (A) and (B), each obtained by polymerization in emulsion in aqueous medium of a composition of monomers A and B respectively:
(a) at least one monomer with an ethylene unsaturation polymerizable by radical route, comprising a functional group, of formula A 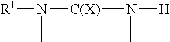
in which
R¹ is a group polymerizable by radical route;
X represents O or S, entering into the composition of monomers A; and
(b) at least one monomer with an ethylene unsaturation polymerizable by radical route, comprising
an 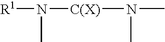
radical identical or different to that of monomer (a), in which R¹ is a group polymerizable by radical route and X represents O or S;
a functional group chosen from acetal, mercaptal, mercaptol, dioxolane and dithiolane, of formula B1
B1: —CHOH-(G)-CH(YR³)(ZR⁴)
in which
Y and Z, identical or different, represent O or S;
G represents a direct bond or a C₁-C₄ alkylene radical;
R³ and R⁴, identical or different, each represent a hydrogen atom or a C₁-C₈ alkyl group, or together form a —CH₂—CR⁵R⁶—(CH₂)ₙ— group where n=0 or 1 and R⁵ and R⁶, identical or different, each represent a hydrogen atom or a methyl group, entering into the composition of monomers B.

2. System according to claim 1, characterized in that the monomer (b) is generated in situ in the polymerization medium.

3. System according to claim 1, characterized in that the radical of the monomers (a) and (b): 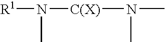
is identical for these two monomers.

4. System according to claim 1, characterized in that the radical of the monomer (a) and/or (b): 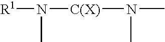
is chosen from those represented by the formulae (I) to (V) hereafter: 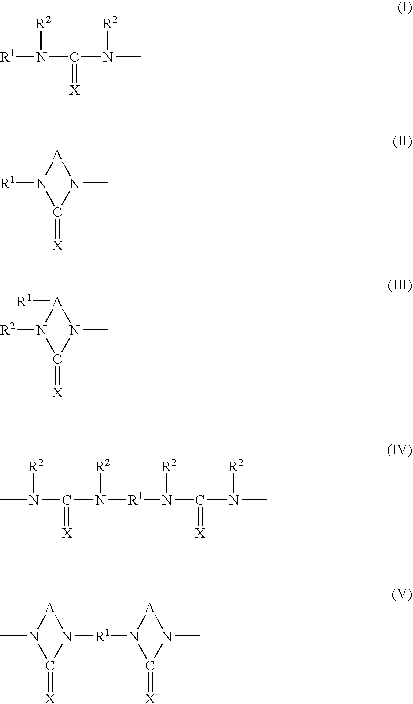
in which: X represents O or S;
R¹ is a group with an ethylene unsaturation, polymerizable by radical route;
R² is a hydrogen atom or a C₁-C₈ alkyl group; and
A is an alkylene chain with 2 or 3 carbon atoms which can be substituted by Cl-C₄ lower alkyl and/or hydroxy and/or C₁-C₄ alkoxy, and/or which can be interrupted by a carbonyl group.

5. System according to claim 1, characterized by the fact that R¹ is chosen from the groups:
CH₂═CH—
CH₂═CH—CH₂—
CH₂═C(CH₃)—CH₂—
CH₂═CH—C(O)—
CH₂═C(CH₃)—C(O)—
CH₂═CH—CH₂—O—CH₂—CH(OH)—CH₂—
R⁷-A¹-Alk
where:
R⁷ represents a hydrogen atom, a 3-alkyloxy-2-hydroxypropyl, vinyl, methacryloyl, acryloyl or methacryloyloxyaceto group;
A¹ represents O, NH or NR⁸;
R⁸ represents 3-allyloxy-2-hydroxypropyl when R⁷ represents 3-allyloxy-2-hydroxypropyl;
Alk represents a C₂-C₈ alkylene chain; and
2-(beta-carboxyacrylamido)ethyl
R⁹-A²-C(O)—CH═CH—C(O)-A²-R⁹
where:
A represents O or NH;
R⁹represents a C₁-C₄ alkylene group.

6. System according to claim 1, characterized in that the radical of the monomers (a) and/or (b): 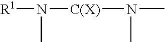
is derived from a compound chosen from N-(2-methacryloyloxyethyl)ethylene urea, N-(2-acryloyloxyethyl) ethylene urea, N-(methacrylamidomethylene) ethylene urea, N-(acrylamidomethylene)-ethylene urea, N-(beta methacrylamidoethyl)-ethylene urea, N-(beta acrylamidoethyl-ethylene urea, N-vinyl-ethylene urea, N-vinyloxyethyl-ethylene urea, N-[beta methacryloyloxyacetamido)-ethyl]-N,N′-ethylene urea, N-[beta-acryloyloxyacetamido)-ethyl]-ethylene urea, 1-[2-[[2-hydroxy-3-(2-propenyloxy)propylamino]ethyl]-2-imidazolidone, N-methacrylamidomethyl urea, N-methacryloyl urea, N-(3-[1,3-diazacyclohexan-2-one]propyl)methacrylamide, N-hydroxyethylethylene urea, N-aminoethyl ethylene urea, N-(3-allyloxy-2-hydroxypropyl) aminoethyl ethylene urea, N-methacrylaminoethyl ethylene urea, N-acrylaminoethyl ethylene urea, N-methacryloxyacetoxyethyl ethylene urea, N-methacryloxy-acetaminoethyl ethylene urea and N-di(3-allyloxy-2-hydroxy-propyl) aminoethyl ethylene urea, N-(2-acryloyl-oxy-ethyl) ethylene urea, N-methacrylamidomethyl urea, allyl alkyl ethylene ureas and the compounds obtained by the reaction between an unsaturated dicarboxylic acid diester and a hydroxyalkylalkylene urea, an aminoalkylalkylene urea, a hydroxyalkylurea or an aminoalkylurea.

7. System according to claim 6, characterized in that said radical is derived from the compound N-(2-methacryloyloxyethyl)-ethylene urea.

8. System according to claim 1, characterized in that, in the formula of the monomer (b): 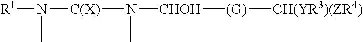
X, Y and Z, identical, represent O;
G represents a direct bond or a C₁-C₄ alkylene radical;
R¹ is as defined in claims 1 to 7;
R³ and R⁴, identical, each represent a C₁-C₄ alkyl group.

9. System according to claim 1, characterized in that the functional group of formula B1 —CHOH-(G)-CH(YR³)(ZR⁴) of the monomer (b) is derived from a compound chosen from 2,2-dimethoxyacetaldehyde, 2,2-diethoxyacetaldehyde, 2,2-dipropoxyacetaldehyde, 2,2-dibutoxyacetaldehyde, 3,3-dimethoxypropanal, 3,3-diethoxypropanal, 3,3-dipropoxypropanal, 3,3-dibutoxypropanal, 4,4-dimethoxybutanal, 4,4-diethoxybutanal, 4,4-dipropoxybutanal, 4,4-dibutoxybutanal, 5,5-dimethoxypentanal, 5,5-diethoxypentanal, 5,5-dipropoxypentanal, 5,5-dibutoxypentanal, 6,6-dimethoxyhexanal, 6,6-diethoxyhexanal, 6,6-dipropoxyhexanal and 6,6-dibutoxyhexanal.

10. System according to claim 1, characterized in that the CHOH-(G)-CH(YR³)(ZR⁴) group of the monomer (b) is derived from 2,2-dimethoxyacetaldehyde.

11. System according to claim 1, characterized by the fact that the monomers (a) and (b) represent 0.5 to 10% by weight of the composition of monomers A and B respectively.

12. System according to claim 1, characterized by the fact that the proportions of the two co-reactive latexes are chosen such that the proportion of the polymer (A) is comprised between 5 and 95% by weight of the polymers (A) and (B), and the proportion of the polymer (B) is comprised between 95 and 5% by weight of the polymers (A) and (B), the dry extracts of each of the dispersions being comprised between 20 and 60% by weight.

13. System according to claim 1, characterized by the fact that the dimensions of the particles of each of the dispersions (A) and (B) are comprised between 50 and 500 nm.

14. System according to claim 1, characterized by the fact that the monomers other than the monomers (a) and (b) of the two dispersions of particles (A) and (B) are chosen so that the glass transition temperatures (Tg) of the resultant copolymers are adapted to the intended field of application, by the combination of monomers suitable for leading to homopolymers having a high Tg with monomers suitable for leading to homopolymers having a low Tg.

15. System according to claim 14, characterized by the fact that the monomers suitable for leading to homopolymers having a low Tg are chosen from ethyl acrylate, butyl acrylate, 2-ethyl hexyl acrylate, nonyl acrylate, vinyl 2-ethyl hexanoate; and the monomers suitable for leading to homopolymers having a high Tg are chosen from methyl methacrylate, vinyl acetate, styrene, acrylic acid, methacrylic acid, acrylamide.

16. Use of a single-component system based on co-reactive latex, as defined in claim 1, as a binding agent in compositions intended to constitute a cross-linkable formol-free coating, such as a paint in the building field, a varnish or a dressing for leather, a finish for textiles, a wood-protection varnish, or in compositions for the coating of paper; as a binding agent and/or an impregnation agent for various woven or non-woven textile materials, paper, cardboard, laps; and as an adhesive, in particular in the wood industry.

17. Method for the preparation of a single-component system according to claim 1, comprising the following stages:
(i) provision of at least one monomer (a) and at least one monomer (b);
(ii) polymerization in emulsion in aqueous medium of each of the compositions of monomers (a) and (b) separately, and the obtaining of dispersions of particles (A) and (B) respectively and
(iii) mixture of the dispersions.

18. Method according to claim 17 comprising in addition an in-situ synthesis stage of monomer (b) by reaction of a composition of monomer (a) with a compound carrying an aldehyde function and a precursor of the acetal, mercaptal, mercaptol, dioxolane or dithiolane function, of formula B′1 CHO-(G)-CH(YR³) (ZR⁴).
